(19) United States
(12) Patent Application Publication
(10) Pub. No.: US 2026/0079359 A1
(43) Pub. Date: Mar. 19, 2026

(54) THERMO-OPTIC PHASE SHIFTER ARRAY, INTERFEROMETER ARRAY, AND OPTICAL PHASED ARRAY

(71) Applicant: SILITH TECHNOLOGY (SUZHOU) CO., LTD., Shanghai (CN)

(72) Inventors: Xingyu ZHANG, Shanghai (CN); Ke ZHANG, Shanghai (CN)

(73) Assignee: SILITH TECHNOLOGY (SUZHOU) CO., LTD., Shanghai (CN)

(21) Appl. No.: 18/994,064

(22) PCT Filed: Oct. 28, 2022
(86) PCT No.: PCT/CN2022/128184

§ 371 Date: Jan. 14, 2025

(30) Foreign Application Priority Data
Aug. 9, 2022 (CN) 202210947415.4

(51) Int. Cl. G02F 1/01; G02F 1/225

(52) U.S. Cl. CPC G02F 1/0147; G02F 1/225; G02F 2201/063; G02F 2201/066

(57) ABSTRACT

Provided in the present invention is a thermo-optic phase shifter array, including at least one first waveguide and at least one second waveguide, where the first waveguide extends in a first direction, the second waveguide extends in a second direction, the first waveguides and the second waveguides are alternately arranged in a third direction, the first waveguide includes a first waveguide section, the second waveguide includes a second waveguide section, the first waveguide sections and the second waveguide sections are alternately arranged in the third direction, the first waveguide section is integrated with a heater, and a thermo-optic coefficient of the second waveguide section is smaller than that of the first waveguide sections. The thermo-optic phase shifter array provided by the present invention has lower thermal crosstalk, and has a compact structure, facilitating high-density integration. The present invention further provides an interferometer array and an optical phased array.

### TECHNICAL FIELD

The present invention relates to the technical field of phase shifters, in particular to a thermo-optic phase shifter array, an interferometer array, and an optical phased array.

### BACKGROUND

A plurality of waveguides arranged into an array are basic building blocks in a photonic integrated circuit, and they are useful in many applications. When all or part of the waveguides are integrated with heaters, this structure can be used as a thermo-optic phase shifter array. When one waveguide is heated, thermal energy will dissipate to nearby waveguides, this thermal crosstalk being undesirable. In the prior art, in order to keep the thermal crosstalk at a low level, a common method is to keep waveguides far enough from each other, and thus the whole structure occupies a large space on a photonic chip, which is against high-density integration, chip miniaturization, and chip cost reduction. Another method is to add side trenches or undercuts around each waveguide for thermal isolation, which increases the complexity of a manufacturing process and also causes certain potential reliability problems.

Therefore, it is necessary to provide a novel thermo-optic phase shifter array, an interferometer array, and an optical phased array to solve the above problems existing in the prior art.

### SUMMARY

The present invention aims to provide a thermo-optic phase shifter array, an interferometer array, and an optical phased array, having lower thermal crosstalk and compact structures.

To achieve the above purposes, the thermo-optic phase shifter array of the present invention comprises at least one first waveguide and at least one second waveguide, where the first waveguide extends in a first direction, the second waveguide extends in a second direction, and the first waveguides and the second waveguides are alternately arranged in a third direction; the first waveguide comprises a first waveguide section, the second waveguide comprises a second waveguide section, and the first waveguide sections and the second waveguide sections are alternately arranged in the third direction; and the first waveguide section is integrated with a heater, and a thermo-optic coefficient of the second waveguide section is smaller than that of the first waveguide section.

The thermo-optic phase shifter array has the following beneficial effects: the first waveguide sections and the second waveguide sections are alternately arranged in the third direction, the first waveguide section is integrated with the heater, the thermo-optic coefficient of the second waveguide section is smaller than that of the first waveguide section, the second waveguide section has lower sensitivity to temperature changes, the second waveguide section is thus less affected by heat dissipation of the first waveguide section, thereby achieving lower thermal crosstalk, and the waveguides do not need to be kept far enough from each other to reduce thermal crosstalk, thereby achieving a compact structure and facilitating high density integration, chip miniaturization and cost reduction.

Optionally, the first waveguide further comprises a third waveguide section, the second waveguide further comprises a fourth waveguide section, the first waveguide section and the third waveguide section are arranged in parallel in the first direction, the second waveguide section and the fourth waveguide section are arranged in parallel in the second direction, the third waveguide sections and the fourth waveguide sections are alternately arranged in the third direction, the fourth waveguide section is integrated with a heater, and a thermo-optic coefficient of the third waveguide section is smaller than that of the fourth waveguide section.

The third waveguide section has lower sensitivity to temperature changes, and the third waveguide section is thus less affected by heat dissipation of the fourth waveguide section. Therefore, when both the first waveguide and the fourth waveguide are integrated with heaters, the thermo-optic phase shifter array still has lower thermal crosstalk.

Optionally, the first direction is parallel to the second direction.

Optionally, the third direction is perpendicular to the first direction.

Optionally, the first waveguide further comprises a first transition region, and the first transition region is arranged between the first waveguide section and the third waveguide section and is used for connecting the first waveguide section to the third waveguide section and reducing an additional optical loss at a connection interface.

Optionally, the second waveguide further comprises a second transition region, and the second transition region is arranged between the second waveguide section and the fourth waveguide section and is used for connecting the second waveguide section to the fourth waveguide section and reducing an additional optical loss at a connection interface.

Optionally, the first waveguide section and the second waveguide section are made of waveguide materials with different thermo-optic coefficients.

Optionally, the first waveguide section and the second waveguide section have waveguide structures with different thermo-optic coefficients.

The present invention further provides an interferometer array, comprising the thermo-optic phase shifter array.

The interferometer array has the following beneficial effects: the first waveguide sections and the second waveguide sections are alternately arranged in the third direction, the first waveguide section is integrated with the heater, the thermo-optic coefficient of the second waveguide section is smaller than that of the first waveguide section, the second waveguide section thus has lower sensitivity to temperature changes, the second waveguide section is then less affected by heat dissipation of the first waveguide section. Therefore, the interferometer array of the present invention has lower thermal crosstalk. First waveguide sections and second waveguide sections of adjacent interferometers are also adjacent, such that lower thermal crosstalk also exists between adjacent arrays.

The present invention further provides an optical phased array, comprising the thermo-optic phase shifter array.

The optical phased array has the following beneficial effects: the first waveguide sections and the second waveguide sections are alternately arranged in the third direction, the first waveguide section is integrated with the heater, the thermo-optic coefficient of the second waveguide section is smaller than that of the first waveguide section, the second waveguide section thus has lower sensitivity to temperature changes, the second waveguide section is then less affected by heat dissipation of the first waveguide section. Therefore, the optical phased array of the present invention has lower thermal crosstalk.

### BRIEF DESCRIPTION OF THE DRAWINGS

FIG. 1 is a top view of a thermo-optic phase shifter array in some embodiments;

FIG. 2 is a top view of a thermo-optic phase shifter array in some other embodiments;

FIG. 3 is a schematic three-dimensional view of a first transition region in some embodiments;

FIG. 4 is a schematic three-dimensional view of a second transition region in some embodiments;

FIG. 5 is a top view of a second transition region in some other embodiments;

FIG. 6 is a front view of a second transition region in some other embodiments;

FIG. 7 is a schematic diagram of an interferometer array in some embodiments;

FIG. 8 is a schematic diagram of an interferometer array in some other embodiments;

FIG. 9 is a schematic diagram of an optical phased array in some embodiments; and

FIG. 10 is a schematic diagram of an optical phased array in some other embodiments.

### DETAILED DESCRIPTION

In order to make the purpose, technical solutions and advantages of the present invention clearer, the technical solutions in the embodiments of the present invention will be clearly and completely described below in conjunction with the drawings of the present invention. Obviously, the described embodiments are part of, but not all of, the embodiments of the present invention. Based on the embodiments of the present invention, all other embodiments obtained by those of ordinary skill in the art without creative work are within the protection scope of the present invention. Unless otherwise defined, technical or scientific terms used herein should be given their ordinary meanings as understood by those of ordinary skill in the art to which the present invention belongs. As used herein, terms “include/comprise” and the like mean that an element or item appearing before the term encompasses elements or items appearing after the term and their equivalents, but does not exclude other elements or items.

In view of the problems existing in the prior art, an embodiment of the present invention provides a thermo-optic phase shifter array, comprising at least one first waveguide and at least one second waveguide, where the first waveguide extends in a first direction, the second waveguide extends in a second direction, the first waveguides and the second waveguides are alternately arranged in a third direction, the first waveguide comprises a first waveguide section, the second waveguide comprises a second waveguide section, the first waveguide sections and the second waveguides section are alternately arranged in the third direction, the first waveguide section is integrated with a heater, and a thermo-optic coefficient of the second waveguide section is smaller than that of the first waveguide section.

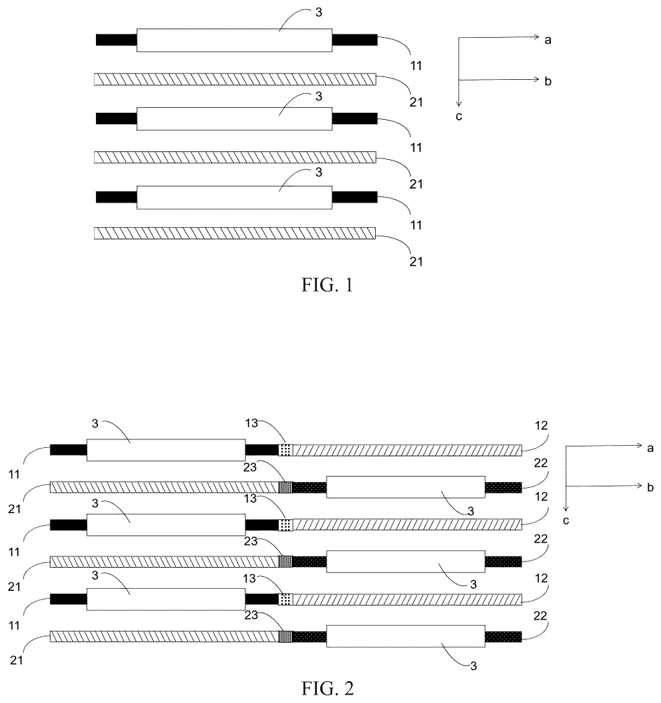

FIG. 1 is a top view of a thermo-optic phase shifter array in some embodiments. Referring to FIG. 1, the thermo-optic phase shifter array comprises three first waveguides and three second waveguides, where the first waveguides extend in a first direction a, the second waveguides extend in a second direction b, and the first waveguides and the second waveguides are alternately arranged in a third direction c; the first waveguide comprises a first waveguide section 11, the second waveguide comprises a second waveguide section 21, and the first waveguide sections 11 and the second waveguide sections 21 are alternately arranged in the third direction c; and the first waveguide section 11 is integrated with a heater 3, and a thermo-optic coefficient of the second waveguide section 21 is smaller than that of the first waveguide section 11.

The first waveguide sections 11 and the second waveguide sections 21 are alternately arranged in the third direction c, the first waveguide section 11 is integrated with the heater 3, the thermo-optic coefficient of the second waveguide section 21 is smaller than that of the first waveguide section 11, the second waveguide section 21 has lower sensitivity to temperature changes, the second waveguide section 21 is thus less affected by heat dissipation of the first waveguide section 11, enabling the thermo-optic phase shifter array of the present invention to have lower thermal crosstalk, and the waveguides do not need to be kept far enough from each other to reduce thermal crosstalk, thereby achieving a compact structure and facilitating high-density integration, chip miniaturization and cost reduction.

The thermo-optic phase shifter array provided by the present invention does not need side trenches or undercuts to isolate thermal diffusion between nearby waveguides, thereby simplifying the manufacturing process, facilitating reduction of the processing and manufacturing costs, and avoiding the reliability problems caused by the side trenches or undercuts.

In some embodiments, the first waveguide further comprises a third waveguide section, the second waveguide further comprises a fourth waveguide section, the first waveguide section and the third waveguide section are arranged in parallel in the first direction, the second waveguide section and the fourth waveguide section are arranged in parallel in the second direction, the third waveguide sections and the fourth waveguide sections are alternately arranged in the third direction, the fourth waveguide section is integrated with a heater, and a thermo-optic coefficient of the third waveguide section is smaller than that of the fourth waveguide section.

FIG. 2 is a top view of a thermo-optic phase shifter array in some other embodiments. Referring to FIG. 2, the first waveguide further comprises a third waveguide section 12, the second waveguide further comprises a fourth waveguide section 22, the first waveguide section 11 and the third waveguide section 12 are arranged in parallel in the first direction a with extension directions on the same straight line, the second waveguide section 21 and the fourth waveguide section 22 are arranged in parallel in the second direction b with extension directions on the same straight line, the third waveguide sections 12 and the fourth waveguide sections 22 are alternately arranged in the third direction c, the fourth waveguide section 22 is integrated with a heater 3, and a thermo-optic coefficient of the third waveguide section 12 is smaller than that of the fourth waveguide section 22.

The first waveguide further comprises the third waveguide section 12, the second waveguide further comprises the fourth waveguide section 22, the third waveguide sections 12 and the fourth waveguide sections 22 are alternately arranged in the third direction c, the fourth waveguide section 22 is integrated with a heater 3, a thermo-optic coefficient of the third waveguide section 12 is smaller than that of the fourth waveguide section 22, the third waveguide section 12 thus has lower sensitivity to temperature changes, the third waveguide section 12 is then less affected by heat dissipation of the fourth waveguide section 22, and therefore, when both the first waveguide and the fourth waveguide are integrated with heaters, the thermo-optic phase shifter array still has lower thermal crosstalk.

In some embodiments, the second waveguide section is the same as the third waveguide section and the first waveguide section is the same as the fourth waveguide section.

In some embodiments, referring to FIGS. 1 and 2, the first direction a is parallel to the second direction b.

In some embodiments, referring to FIGS. 1 and 2, the first direction a is parallel to the second direction b, and the third direction c is perpendicular to the first direction a.

In some embodiments, the first waveguide further comprises a first transition region, and the first transition region is arranged between the first waveguide section and the third waveguide section and is used for connecting the first waveguide section to the third waveguide section and reducing an additional optical loss at a connection interface.

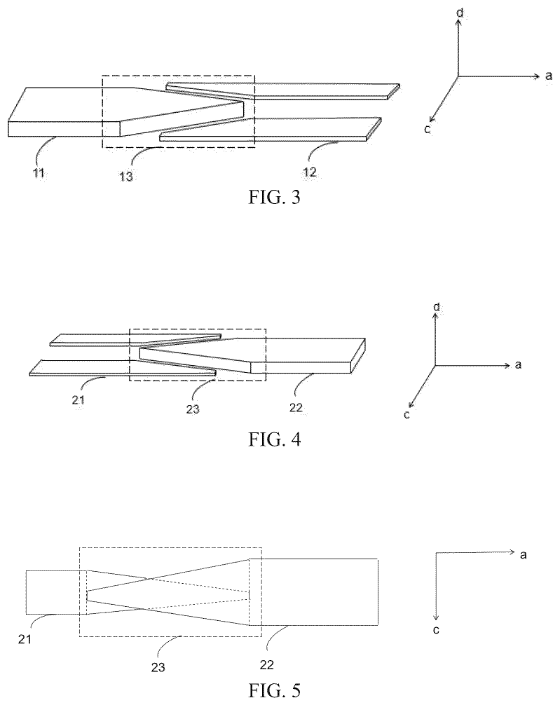

FIG. 3 is a schematic three-dimensional view of a first transition region in some embodiments. Referring to FIGS. 2 and 3, the first waveguide section 11 and the third waveguide section 12 are connected through the first transition region 13, the third waveguide section 12 is a slot waveguide, a top plane of the first waveguide section 11 protruding at a right end is triangular, and the left side of the third waveguide section 12 is sunken, enabling the right end of the first waveguide section 11 to extend into the sunken region of the third waveguide section 12.

In some embodiments, the second waveguide further comprises a second transition region, and the second transition region is arranged between the second waveguide section and the fourth waveguide section and is used for connecting the second waveguide section to the fourth waveguide section and reducing an additional optical loss at a connection interface.

FIG. 4 is a schematic three-dimensional view of a second transition region in some embodiments. Referring to FIGS. 2 and 4, the second waveguide section 21 and the fourth waveguide section 22 are connected through the second transition region 23, the second waveguide section 21 is a slot waveguide, a top plane of the fourth waveguide section 22 protruding at a left end is triangular, and the right side of the second waveguide section 21 is sunken, enabling the left end of the fourth waveguide section 22 to extend into the sunken region of the second waveguide section 21.

In some embodiments, types of the first transition region and the second transition region comprise an interlayer transition and a waveguide type transition.

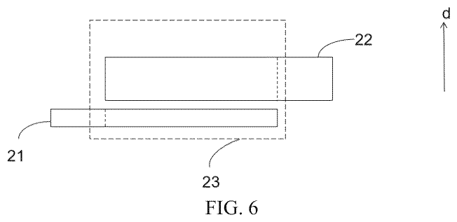

FIG. 5 is a top view of a second transition region in some other embodiments, and FIG. 6 is a side view of a second transition region in some other embodiments. Referring to FIGS. 5 and 6, the third waveguide section 12 and the fourth waveguide section 22 are arranged on layers of different heights in the fourth direction d.

In still other embodiments, a top view of the first transition region can also be as shown in FIG. 5, and a side view of the first transition region can also be as shown in FIG. 6.

In some embodiments, the first waveguide section 11, the second waveguide section 21, the third waveguide section 12, and the fourth waveguide section 22 are arranged on a layer with the same height in the fourth direction d.

In some embodiments, the first waveguide section and the second waveguide section are made of waveguide materials with different thermo-optic coefficients. In some specific embodiments, the first waveguide section comprises silicon material and the second waveguide section comprises silicon nitride material.

In some embodiments, the third waveguide section and the fourth waveguide section are made of waveguide materials with different thermo-optic coefficients. In some specific embodiments, the third waveguide section comprises silicon nitride material and the second waveguide section comprises silicon material.

In some embodiments, the first waveguide section and the second waveguide section have waveguide structures with different thermo-optic coefficients.

In some embodiments, the third waveguide section and the fourth waveguide section have waveguide structures with different thermo-optic coefficients.

The present invention further provides an interferometer array, comprising the thermo-optic phase shifter array.

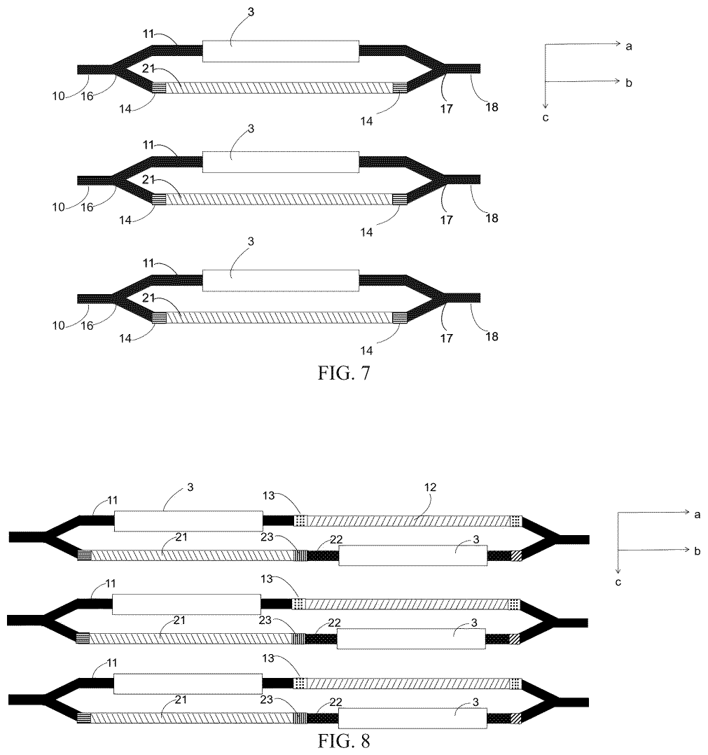

FIG. 7 is a schematic diagram of an interferometer array in some embodiments. Referring to FIG. 7, the interferometer array comprises three interferometers, each of the interferometers comprises two optical waveguide arms, an input optical waveguide section 10 and an output optical waveguide section 18, the input optical waveguide section 10 is split into a first optical waveguide arm and a second optical waveguide arm by an optical splitter 16, the first optical waveguide arm and the second optical waveguide arm are parallel, and the first optical waveguide arm and the second optical waveguide arm are combined into the output optical waveguide section 18 by an optical combiner 17. The first optical waveguide arm comprises the first waveguide section 11, the second optical waveguide arm comprises the second waveguide section 21 and two third transition regions 14, the two third transition regions 14 are opposite in the second direction b, the first waveguide sections 11 and the second waveguide sections 21 are alternately arranged in the third direction c, the two third transition regions 14 are arranged at two ends of the second waveguide section 21, the first waveguide section 11 is integrated with the heater 3, and the thermo-optic coefficient of the second waveguide section 21 is smaller than that of the first waveguide section 11.

In some embodiments, the interferometer comprises n optical waveguide arms, n being an integer greater than 2.

In some embodiments, the n optical waveguide arms are parallel or not parallel.

In some embodiments, the optical waveguide arm is in a linear, curved, or spiral shape.

In some embodiments, an arm length of the optical waveguide arm can be modified, thereby achieving the same optical path length or a specific optical path length difference.

In the interferometer array provided by the present invention, the first waveguide sections 11 and the second waveguide sections 21 are alternately arranged in the third direction c, the first waveguide section 11 is integrated with the heater 3, the thermo-optic coefficient of the second waveguide section 21 is smaller than that of the first waveguide section 11, the second waveguide section 21 has lower sensitivity to temperature changes, the second waveguide section 21 is thus less affected by heat dissipation of the first waveguide section 11, enabling the interferometer array of the present invention to have lower thermal crosstalk, and the waveguides do not need to be kept far enough from each other to reduce thermal crosstalk, thereby achieving a compact structure and facilitating high-density integration, chip miniaturization and cost reduction. First waveguide sections and second waveguide sections of adjacent interferometers are also adjacent, such that lower thermal crosstalk also exists between adjacent arrays.

FIG. 8 is a schematic diagram of an interferometer array in some other embodiments. Referring to FIG. 8, the first optical waveguide arm further comprises the third waveguide section 12, the second optical waveguide arm further comprises the fourth waveguide section 22, the first waveguide section 11 and the third waveguide section 12 are connected by the first transition region 13, the second waveguide section 21 and the fourth waveguide section 22 are connected by the second transition region 23, the third waveguide sections 12 and the fourth waveguide sections 22 are alternately arranged in the third direction c, and the thermo-optic coefficient of the third waveguide section 12 is smaller than that of the fourth waveguide section 22.

In the interferometer array provided by the present invention, the third waveguide sections 12 and the fourth waveguide sections 22 are alternately arranged in the third direction c, the fourth waveguide section 22 is integrated with the heater 3, the thermo-optic coefficient of the third waveguide section 12 is smaller than that of the fourth waveguide section 22, the third waveguide section 12 has lower sensitivity to temperature changes, the third waveguide section 12 is thus less affected by heat dissipation of the fourth waveguide section 22, enabling the interferometer array of the present invention to have lower thermal crosstalk, and the waveguides do not need to be kept far enough from each other to reduce thermal crosstalk, thereby achieving a compact structure and facilitating high-density integration, chip miniaturization and cost reduction. Third waveguide sections and fourth waveguide sections of adjacent interferometers are also adjacent, such that lower thermal crosstalk also exists between adjacent arrays.

The present invention further provides an optical phased array, comprising the thermo-optic phase shifter array.

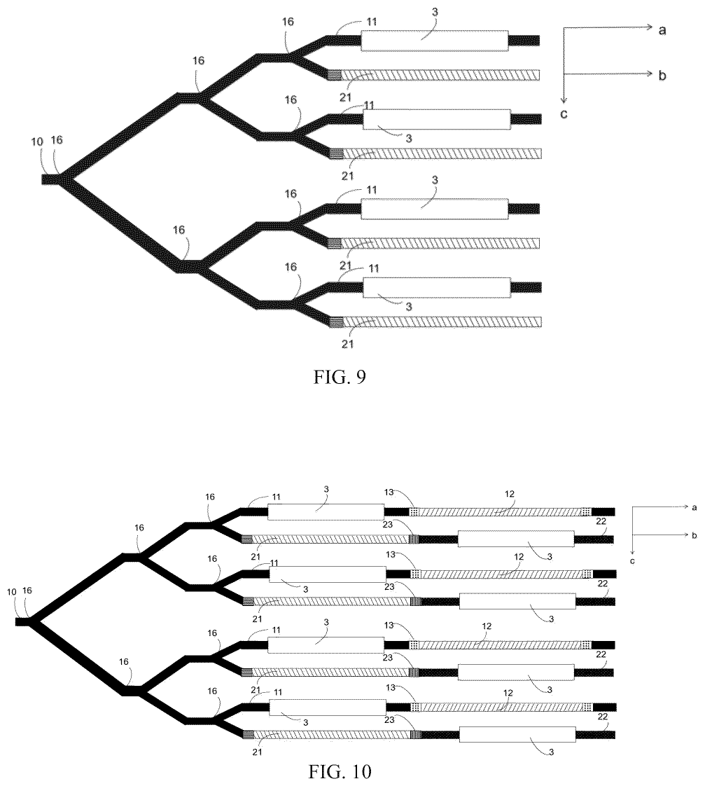

FIG. 9 is a schematic diagram of an optical phased array in some embodiments. Referring to FIG. 9, the first input optical waveguide section 10 is split into two input optical waveguide sections by the optical splitter 16, each of the input optical waveguide sections is then split into two groups of waveguides by twice optical splitting of the optical splitter 16, the optical phased array comprises four groups of waveguides, each group of the waveguides comprises a first waveguide and a second waveguide, and the first waveguide and the second waveguide are parallel. The first waveguide comprises the first waveguide section 11, the second waveguide comprises the second waveguide section 21, the first waveguide sections 11 and the second waveguide sections 21 are alternately arranged in the third direction c, the first waveguide section 11 is integrated with the heater 3, and the thermo-optic coefficient of the second waveguide section 21 is smaller than that of the first waveguide section 11.

FIG. 10 is a schematic diagram of an optical phased array in some other embodiments. Referring to FIG. 10, the first input optical waveguide section 10 is split into two input optical waveguide sections by the optical splitter 16, each of the input optical waveguide sections is then split into two groups of waveguides by twice optical splitting of the optical splitter 16, the optical phased array comprises four groups of waveguides, each group of the waveguides comprises a first waveguide and a second waveguide, and the first waveguide and the second waveguide are parallel. The first waveguide comprises the first waveguide section 11 and the third waveguide section 12, the first waveguide section 11 and the third waveguide section 12 are connected by the first transition region 13, the second waveguide comprises the second waveguide section 21 and the fourth waveguide section 22, the second waveguide section 21 and the fourth waveguide section 22 are connected by the second transition region 23, the first waveguide sections 11 and the second waveguide sections 21 are alternately arranged in the third direction c, the third waveguide section 12 and the fourth waveguide section 22 are alternately arranged in the third direction c, the first waveguide section 11 and the fourth waveguide section 22 are integrated with the heaters 3, the thermo-optic coefficient of the second waveguide section 21 is smaller than that of the first waveguide section 11, and the thermo-optic coefficient of the third waveguide section 12 is smaller than that of the fourth waveguide section 22.

In the optical phased array provided by the present invention, the first waveguide sections 11 and the second waveguide sections 21 are alternately arranged in the third direction c, the third waveguide sections 12 and the fourth waveguide sections 22 are alternately arranged in the third direction c, the first waveguide section 11 and the fourth waveguide section 22 are integrated with the heaters 3, the thermo-optic coefficient of the second waveguide section 21 is smaller than that of the first waveguide section 11, the thermo-optic coefficient of the third waveguide section 12 is smaller than that of the fourth waveguide section 22, the second waveguide section 21 has lower sensitivity to temperature changes, the second waveguide section 21 is thus less affected by heat dissipation of the first waveguide section 11, the third waveguide section 12 has lower sensitivity to temperature changes, the second waveguide section 12 is thus less affected by heat dissipation of the fourth waveguide section 22, enabling the optical phased array of the present invention to have lower thermal crosstalk, and the waveguides do not need to be kept far enough from each other to reduce thermal crosstalk, thereby achieving a compact structure and facilitating high-density integration, chip miniaturization and cost reduction.

In some embodiments, the first waveguide and the second waveguide are in a linear, curved, or spiral shape.

In some embodiments, the first waveguide and the second waveguide are not parallel.

In some embodiments, the first waveguide section, the second waveguide section, the third waveguide section, or the fourth waveguide section further comprises side trenches and an undercut to further improve thermal isolation.

In some embodiments, materials of the heater comprise titanium nitride, doped silicon, or tungsten.

In some embodiments, an integrated material platform of the thermo-optic phase shifter array comprises bulk silicon, silicon on insulator, silicon on sapphire, silicon dioxide, aluminum oxide, indium phosphide, lithium niobate, and polymer.

In some embodiments, waveguide types of the thermo-optic phase shifter array comprise a channel waveguide, a ridge waveguide, a slot waveguide, a diffused waveguide, and a photonic crystal waveguide.

In some embodiments, an operating wavelength range of the thermo-optic phase shifter array comprises a visible band, an O band, an E band, an S band, a C band, an L band, a U band, and a mid-infrared band.

In some embodiments, application fields of the thermo-optic phase shifter array comprise optical sensing, beam control, lidar, optical interconnection, and optical computing.

While the embodiments of the present invention have been described in detail above, it will be apparent to those skilled in the art that various modifications and variations can be made to the embodiments. It is to be understood, however, that such modifications and variations should all fall within the scope and spirit of the present invention as set forth in the claims. Moreover, the present invention described herein can have other embodiments and can be executed or implement in various ways.

1. A thermo-optic phase shifter array, comprising at least one first waveguide and at least one second waveguide, wherein the first waveguide extends in a first direction, the second waveguide extends in a second direction, the first waveguides and the second waveguides are alternately arranged in a third direction, the first waveguide comprises a first waveguide section, the second waveguide comprises a second waveguide section, the first waveguide sections and the second waveguide sections are alternately arranged in the third direction, the first waveguide section is integrated with a heater, and a thermo-optic coefficient of the second waveguide section is smaller than that of the first waveguide section.

2. The thermo-optic phase shifter array according to claim 1, wherein the first waveguide further comprises a third waveguide section, the second waveguide further comprises a fourth waveguide section, the first waveguide section and the third waveguide section are arranged in parallel in the first direction, the second waveguide section and the fourth waveguide section are arranged in parallel in the second direction, the third waveguide sections and the fourth waveguide sections are alternately arranged in the third direction, the fourth waveguide section is integrated with a heater, and a thermo-optic coefficient of the third waveguide section is smaller than that of the fourth waveguide section.

3. The thermo-optic phase shifter array according to claim 1, wherein the first direction is parallel to the second direction.

4. The thermo-optic phase shifter array according to claim 3, wherein the third direction is perpendicular to the first direction.

5. The thermo-optic phase shifter array according to claim 2, wherein the first waveguide further comprises a first transition region, and the first transition region is arranged between the first waveguide section and the third waveguide section and is used for connecting the first waveguide section to the third waveguide section and reducing an additional optical loss at a connection interface.

6. The thermo-optic phase shifter array according to claim 5, wherein the second waveguide further comprises a second transition region, and the second transition region is arranged between the second waveguide section and the fourth waveguide section and is used for connecting the second waveguide section to the fourth waveguide section and reducing an additional optical loss at a connection interface.

7. The thermo-optic phase shifter array according to claim 1, wherein the first waveguide section and the second waveguide section are made of waveguide materials with different thermo-optic coefficients.

8. The thermo-optic phase shifter array according to claim 1, wherein the first waveguide section and the second waveguide section have waveguide structures with different thermo-optic coefficients.

9. An interferometer array, comprising the thermo-optic phase shifter array according to claim 1.

10. An optical phased array, comprising the thermo-optic phase shifter array according to claim 1.
